(19) United States
(12) Patent Application Publication
(10) Pub. No.: US 2025/0117001 A1
(43) Pub. Date: Apr. 10, 2025

(54) METHOD AND SYSTEM FOR ASSISTING IN DISTINGUISHING BETWEEN SHEET-METAL WORKPIECES

(71) Applicant: TRUMPF Werkzeugmaschinen SE + Co. KG, Ditzingen (DE)

(72) Inventors: Korbinian Weiß, Korntal (DE); Marc Teschner, Stuttgart (DE); Willi Pönitz, Leonberg (DE)

(21) Appl. No.: 18/986,783

(22) Filed: Dec. 19, 2024

Related U.S. Application Data
(63) Continuation of application No. PCT/EP2023/064951, filed on Jun. 5, 2023.

(30) Foreign Application Priority Data
Jun. 28, 2022 (DE) 10 2022 115 997.3

(51) Int. Cl. G05B 19/418

(52) U.S. Cl. CPC G05B 19/41875; G05B 2219/25294

(57) ABSTRACT

A method for assisting in distinguishing between sheet-metal workpieces includes selecting at least a first item of workpiece information of a first workpiece and a second item of workpiece information of a second workpiece, retrieving the first item and the second item of workpiece information by a computing unit from a memory and comparing the first item and the second item with each other, determining, by the computing unit, at least one difference between the first item and the second item of workpiece information, obtaining a respective drawing of the first workpiece or the second workpiece from each of the first item and the second item of workpiece information, and outputting the drawings of the first item and the second item of workpiece information graphically via an output unit. The at least one difference is highlighted in at least one of the drawings.

### CROSS REFERENCE TO RELATED APPLICATIONS

This application is a continuation of International Application No. PCT/EP2023/064951 (WO 2024/002622 A1), filed on Jun. 5, 2023, and claims benefit to German Patent Application No. DE 10 2022 115 997.3, filed on Jun. 28, 2022. The aforementioned applications are hereby incorporated by reference herein.

### FIELD

Embodiments of the present invention relate to a method and system for assisting in distinguishing between sheet-metal workpieces.

### BACKGROUND

A system for recognizing an object is known from DE 10 2018 215 538 A1.

### SUMMARY

Embodiments of the present invention provide a method for assisting in distinguishing between sheet-metal workpieces. For each of a large number of the workpieces, an item of geometric workpiece information is stored in a memory. The method includes selecting at least a first item of workpiece information of a first workpiece and a second item of workpiece information of a second workpiece, retrieving the first item and the second item of workpiece information by a computing unit from the memory and comparing the first item and the second item with each other, determining, by the computing unit, at least one difference between the first item and the second item of workpiece information, obtaining a respective drawing of the first workpiece or the second workpiece from each of the first item and the second item of workpiece information, and outputting the drawings of the first item and the second item of workpiece information graphically via an output unit. The at least one difference is highlighted in at least one of the drawings.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 shows a flow chart of a method according to some embodiments;

FIG. 2 shows a diagram for the selection of an item of workpiece information using an image of a sheet-metal workpiece according to some embodiments;

FIG. 3 shows a diagram for the selection of an item of workpiece information using a workpiece list according to some embodiments;

FIG. 4 shows a diagram for the selection of an item of workpiece information using the recognition of a position of the workpiece according to some embodiments;

FIG. 5 shows an output of a large number of items of workpiece information according to some embodiments;

FIG. 6 shows an output of items of workpiece information in standardized scaling according to some embodiments;

FIG. 7 shows an output of items of workpiece information with different holes according to some embodiments; and

FIG. 8 shows an output of items of workpiece information with different outer contours according to some embodiments.

### DETAILED DESCRIPTION

Embodiments of the present invention provide a method and a system that can support the operator in distinguishing between workpieces made from a metal sheet.

According to embodiments of the invention, in the method, an item of geometric workpiece information is present in a memory for each of a large number of workpieces,
wherein at least one first item of workpiece information of a first workpiece and one second item of workpiece information of a second workpiece is selected,
wherein the selected items of workpiece information are retrieved from the memory by a computing unit and compared with one another,
wherein at least one difference between the selected items of workpiece information is determined by the computing unit,
wherein the items of workpiece information each contain a drawing of the respective workpieces or a drawing being created from the workpiece information,
wherein the drawings of the selected items of workpiece information are output graphically via an output unit and the difference being highlighted in at least one drawing.

The items of geometric workpiece information are stored in the memory in machine-readable form. These can be, for example, CAD data, NC data or drawings.

The two or more items of workpiece information can be selected in several ways, which are discussed in more detail below.

The selected items of workpiece information are preferably compared on the basis of the drawings. Known graphics algorithms can therefore be used. Alternatively, the items of workpiece information can be compared on the basis of the available data, e.g., CAD data or NC data.

If several differences are found during the comparison, only the difference that is most easily recognizable for the operator is displayed.

The highlighting in the drawing can be done, for example, by arrows, outlining, colored backgrounds or similar.

Preferably, the difference is a different size of the workpieces, and the drawings are output scaled to a uniform size. The scaled output makes the difference in size immediately apparent.

Preferably, the difference is a different number and/or arrangement of holes in the workpieces and at least one hole is highlighted in a drawing. By highlighting the hole, the operator can immediately see which hole they need to pay attention to.

Preferably, the difference is a different outer contour of the workpieces, and the drawings are rotated and/or mirrored so that an overlay of the drawings has the greatest possible area overlap and the drawings are output in this rotation and/or mirroring. Rotation and/or mirroring makes it easy for the operator to compare drawings.

Preferably, the drawings are output in an overlayed or juxtaposed manner.

Preferably, an image of a workpiece is taken and the first item of workpiece information is selected based on the image. When selecting workpiece information based on an image, the operator can use a camera to take an image of a workpiece and select the associated item of workpiece information. This is a simple method to select the workpiece information associated with a given workpiece.

Preferably, an item of component information is generated from the image and the first item of workpiece information that is most similar to the item of component information is automatically selected. The component information is preferably at least partially in the same format as the workpiece information. For example, an outer contour of the workpiece can be recognized from the image and compared to the drawing from the item of workpiece information. Optionally, the item of workpiece information with the second-greatest similarity can be selected as the second item of workpiece information.

The similarity of the workpieces can be determined, for example, by artificial intelligence, in particular a neural network. An example of such artificial intelligence is described in DE 10 2018 215 538 A1.

In an alternative embodiment, a first item of workpiece information is selected by an operator and the workpiece information that is most similar to the first item of workpiece information is automatically selected as the second item of workpiece information. The first item of workpiece information can be selected by the operator from the large number of items of workpiece information, for example via an operator interface. By automatically comparing the workpiece information, the item of workpiece information that is most similar to the first item of workpiece information selected by the operator is selected as the second item of workpiece information from the non-selected items of workpiece information.

Preferably, at least one item of workpiece information is selected by an artificial intelligence. The artificial intelligence can be used preferably in the selection mentioned above according to similarity.

In an alternative embodiment, at least a first workpiece is automatically recognized in position in a metal sheet and the first item of workpiece information belonging to the workpiece is selected. The recognition in position in the metal sheet is advantageous when a large number of workpieces have been separated from a metal sheet by a machine tool, in particular a flatbed laser cutting machine, and the remaining metal sheet is present together with the workpieces. Recognition of this kind has been disclosed, for example, in WO 2018/073418 A1.

Embodiments of the present invention also relate to a system for assisting in distinguishing between workpieces, comprising a memory, a computing unit and an output unit, wherein a large number of geometric items of workpiece information are present in the memory, wherein the items of workpiece information each contain a drawing of the respective workpieces or the computing unit can create a drawing from the items of workpiece information, wherein the computing unit is provided and configured to retrieve at least a first item of workpiece information of a first workpiece and a second item of workpiece information of a second workpiece from the memory, to determine at least one difference between the items of workpiece information, and to graphically output the drawings of the selected items of workpiece information via an output unit and to highlight the difference in at least one output drawing.

The system assists the operator in distinguishing between workpieces by outputting drawings of the workpieces and highlighting the difference in at least one drawing.

Preferably, the system comprises a camera for creating an image and the computing unit is provided and configured to select at least a first item of workpiece information based on the image. For example, the camera can be used to record an image of a workpiece and, based on the image, the item of workpiece information belonging to the workpiece can be selected. Alternatively, the camera can be used to record an image of a metal sheet with a large number of workpieces, to recognize a workpiece in position in the metal sheet and to select the item of workpiece information belonging to the workpiece.

Preferably, a trained model of an artificial intelligence is present in the memory and the computing unit is provided and configured to use the model to select at least one item of workpiece information. In particular, the artificial intelligence can determine the similarity between items of workpiece information.

Preferably, the system has an input unit and the computing unit is provided and configured to receive a selection of a first item of workpiece information from an operator via the input unit. Preferably, the computing unit is provided and configured to display the selectable items of workpiece information to the operator via the output unit.

Preferably, the system is provided and configured to carry out a method as described above.

Exemplary embodiments of the present invention are described in greater detail with reference to the drawings.

Elements that are the same or have equivalent functions are denoted by the same reference signs in all the exemplary embodiments.

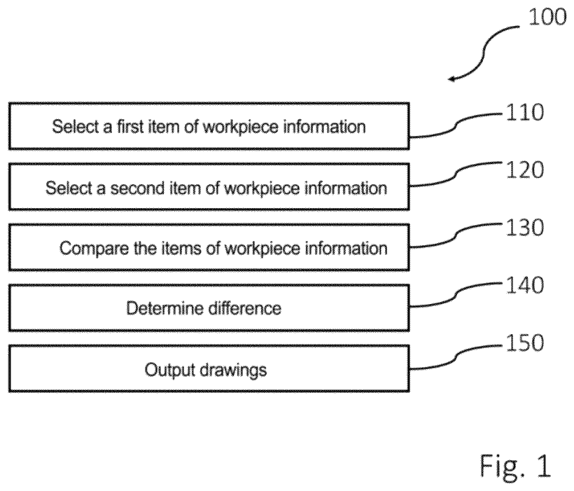

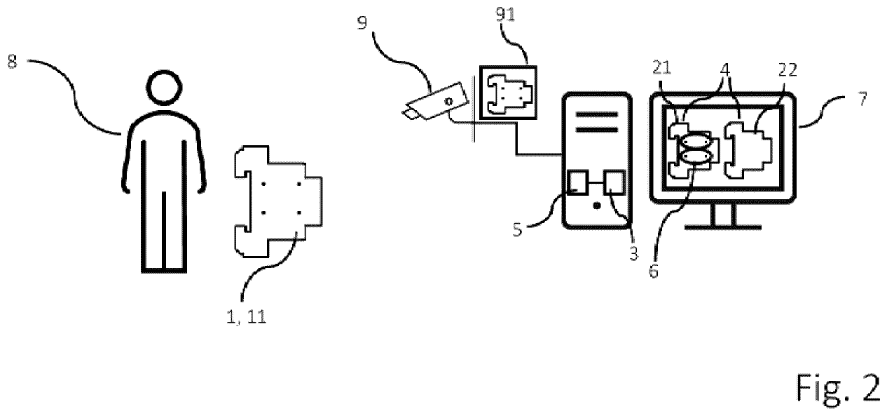

FIG. 1 shows an exemplary embodiment of a flow chart 100. In a first step 110, a first item of workpiece information is selected. In a second step 120, a second item of workpiece information is selected. Several possibilities for selecting the first and the second item of workpiece information are described below in connection with FIGS. 2, 3 and 4. The items of workpiece information each contain a drawing, or a drawing can be created from the item of workpiece information. In a third step 130, the selected items of workpiece information are compared. For this purpose, it may be advantageous to convert the items of workpiece information into the same format. In particular, it can be advantageous to create a drawing of the corresponding workpiece in each case from the items of workpiece information. In a fourth step 140, at least one difference between the selected items of workpiece information is determined. In a fifth step 150, the drawings are output. At least one drawing highlights the difference.

FIG. 2 shows a diagram for selecting an item of workpiece information using an image of a sheet-metal workpiece 1. A first workpiece 11 is held by an operator 8 in the field of view of a camera 9. The camera 9 can be attached to a machine tool, e.g., a laser cutting machine. Preferably, the camera 9 is part of a mobile device, e.g., a smartphone. The camera 9 takes an image 91 of the first workpiece 11 and transmits the image 91 to a computing unit 5. The computing unit 5 is connected to a memory 3. The memory 3 contains an item of geometric workpiece information for each of a large number of workpieces 1. The computing unit 5 selects the item of workpiece information matching the image 91 as the first item of workpiece information. The selection can be made, for example, based on the similarity of the item of workpiece information to the image. The similarity can be determined, for example, using artificial intelligence, in particular a neural network. A corresponding artificial intelligence can be stored in the memory 3 and executed by the computing unit 5 to determine the similarity. The second item of workpiece information can be selected in the same way by creating an image 91 of a second workpiece. Alternatively, the item of workpiece information that is second most similar to image 91 is selected as the second item of workpiece information. The computing unit 5 compares the selected items of workpiece information and determines at least one difference 6 between the selected items of workpiece information. The computing unit 5 is connected to an output unit 7, here a monitor, and outputs the drawings of the items of workpiece information via the output unit 7. In the output, the difference 6 is highlighted, here by outlining different drill holes.

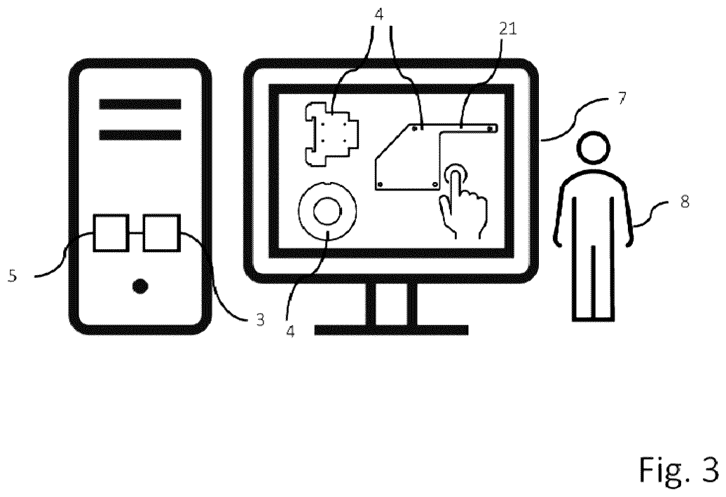

FIG. 3 shows a diagram for the selection of an item of workpiece information using a workpiece list. A large number of items of geometric tool information are stored in a memory 3. A computing unit 5 is connected to the memory 3 and an output unit 7, here a monitor. The computing unit loads several items of tool information from the memory 3 and outputs them via the output unit 7. In this example, the items of workpiece information are output as drawings, but it is also possible to output the information as text, e.g., as a component number or order number. The operator 8 now selects a first item of workpiece information from the output items of workpiece information. In this example, the selection is made via a touchscreen in the output unit. The second item of workpiece information can be selected in the same way. Alternatively, the workpiece information that is most similar to the first item of workpiece information is selected as the second item of workpiece information. The items of workpiece information can be compared using artificial intelligence. The computing unit 5 compares the selected items of workpiece information and determines at least one difference 6 between the selected items of workpiece information. The computing unit 5 outputs the drawings of the items of workpiece information via the output unit 7. The difference 6 is highlighted in the output.

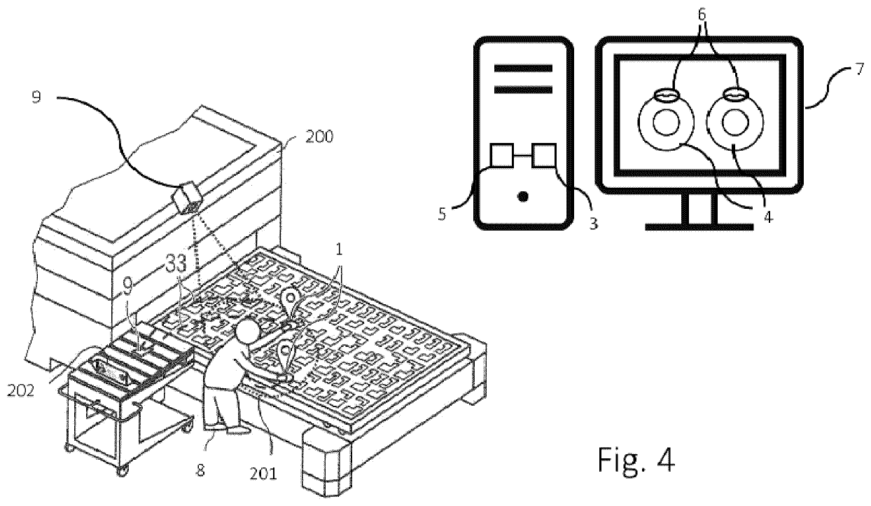

FIG. 4 shows a diagram for the selection of an item of workpiece information by recognizing a position of the workpiece. A machine tool 200, here a laser cutting machine, produces sheet-metal workpieces 1 from a metal sheet. The sheet-metal workpieces 1 are output together with the remaining metal sheet from the machine tool 200 on a pallet 201. An operator 8 removes the sheet-metal workpieces 1 from the remaining metal sheet and sorts the sheet-metal workpieces 1 onto a transport trolley 202. A camera 9 is aimed at the pallet 201 and creates images of the sheet-metal workpieces 1 and the remaining metal sheet. A computing unit 5 is connected to the camera 9 and a memory 3. The items of workpiece information and information about the respective positions of the workpieces 1 in the remaining metal sheet are stored in the memory 3. The computing unit 5 compares the images from the camera 9 to the information about the respective positions of the workpieces 1 and thus determines which workpiece 1 the operator 8 has removed. The item of workpiece information associated with the removed workpiece 1 is selected as the first item of workpiece information. The second item of workpiece information can be selected in the same way for a second removed workpiece. Alternatively, the workpiece information that is most similar to the first item of workpiece information is selected as the second item of workpiece information. The items of workpiece information can be compared using artificial intelligence. The computing unit 5 compares the selected items of workpiece information and determines at least one difference 6 between the selected items of workpiece information. The computing unit 5 outputs the drawings of the items of workpiece information via an output unit 7. The difference 6 is highlighted in the output.

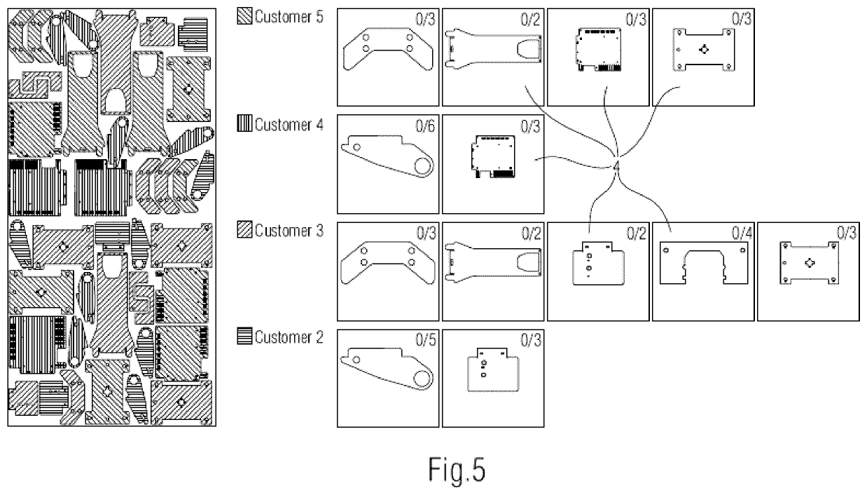

FIG. 5 shows an output of a large number of items of workpiece information. Such a representation can, for example, be output to the operator of a machine tool shown in FIG. 4 via the output unit. A large number of drawings 4 from the items of workpiece information are shown on the right side. In this example, the area provided for displaying a single drawing is always the same size. This enables details to be seen while simultaneously displaying workpieces of different sizes. For each drawing it is indicated how often the corresponding component has been manufactured from the metal sheet and how many have already been removed. In this example, each row shows the workpieces of a customer. In the middle, each customer is assigned a color, shown here as hatching. On the left side the drawings are shown with their respective positions in the remaining metal sheet. Using the representation on the left-hand side, the operator can see which workpieces are located where on the pallet. The color or hatching helps in assigning workpieces to customers so that the components can be sorted according to customer specifications if necessary. The operator can then select items of workpiece information by removing workpieces, as described in connection with FIG. 4.

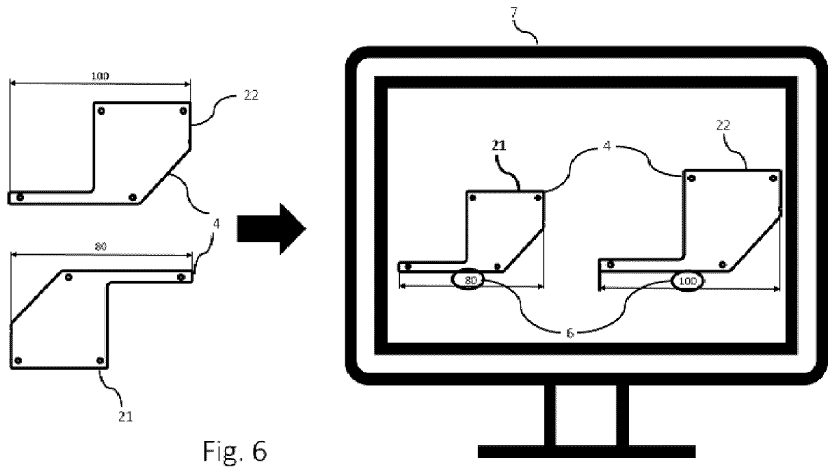

FIG. 6 shows an output of items of workpiece information 21, 22 in standardized scaling. The items of workpiece information 21, 22 selected in this example describe identical geometries with the same aspect ratios but different absolute sizes. Drawings 4 from the items of workpiece information are shown on the left side with the same absolute side lengths as they would be shown on the right side in FIG. 5. The computing unit recognizes the different absolute sizes as the difference for the two selected items of workpiece information 21, 22. For better differentiation, the drawings 4 are output via the output unit 7 to the same scale. In addition, the drawings 4 are rotated so that an overlay of the drawings 4 has the greatest possible area overlap. To emphasize the difference 6, the length specifications are marked, here by outlining.

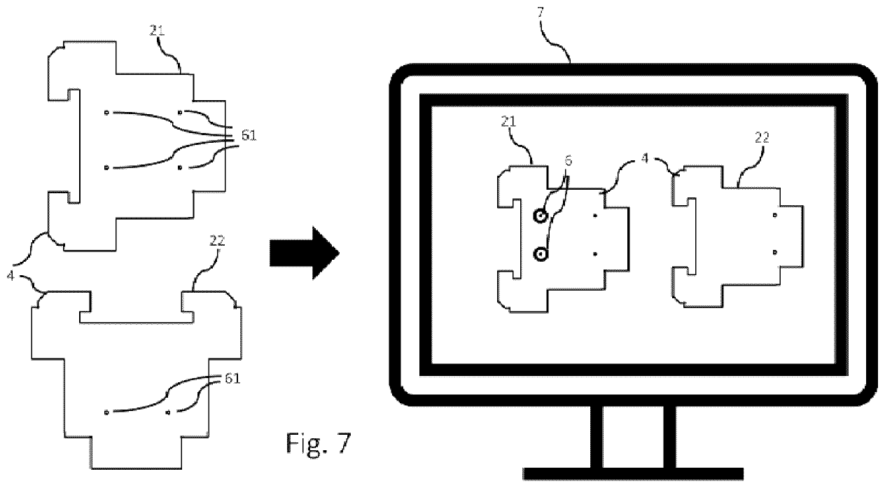

FIG. 7 shows an output of items of workpiece information 21, 22 with different holes 61. The items of workpiece information 21, 22 selected in this example describe identical geometries with different holes. The computing unit recognizes the different holes as a difference for the two selected items of workpiece information. For output, the drawings are rotated so that an overlay of the drawings has the greatest possible area overlap. To highlight the difference 6, the holes are marked, here by outlining.

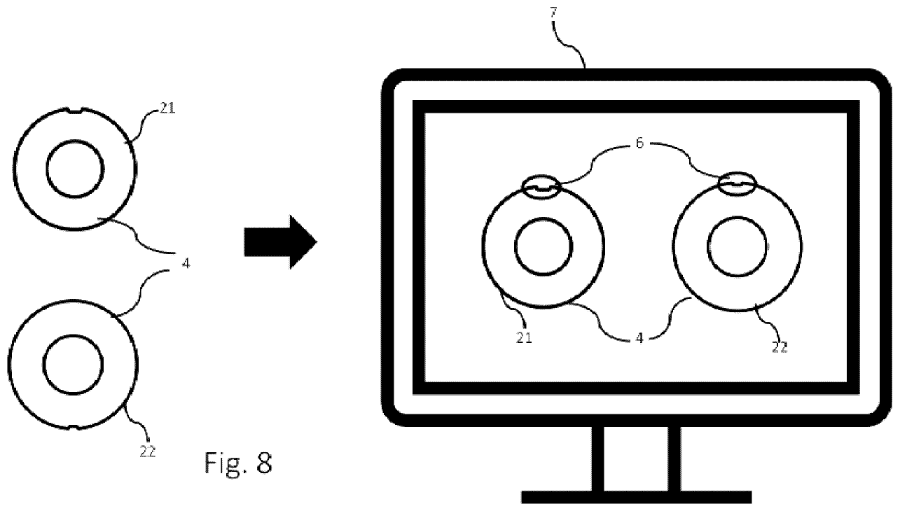

FIG. 8 shows an output of items of workpiece information with different outer contours. The items of workpiece information selected in this example describe approximately circular workpieces. However, the respective outer contours of the workpieces have recesses of different sizes. The computing unit recognizes the different recesses as a difference for the two selected items of workpiece information. For output, the drawings are rotated so that an overlay of the drawings has the greatest possible area overlap. To highlight the difference 6, the recesses are marked, here by outlining.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LIST OF REFERENCE SIGNS

1 Sheet-metal workpiece
11 First workpiece
12 Second workpiece
2 Item of workpiece information
21 First item of workpiece information
22 Second item of workpiece information
3 Memory
4 Drawing
5 Computing unit
6 Difference
61 Holes
7 Output unit
8 Operator
9 Camera
91 Image
100 Flow chart
110 First step
120 Second step
130 Third step
140 Fourth step
150 Fifth step
200 Machine tool
201 Pallet
202 Transport trolley

1. A method for assisting in distinguishing between sheet-metal workpieces, wherein, for each of a large number of the workpieces, an item of geometric workpiece information is stored in a memory, the method comprising:
selecting at least a first item of workpiece information of a first workpiece and a second item of workpiece information of a second workpiece,
retrieving the first item and the second item of workpiece information by a computing unit from the memory and comparing the first item and the second item with each other,
determining, by the computing unit, at least one difference between the first item and the second item of workpiece information,
obtaining a respective drawing of the first workpiece or the second workpiece from each of the first item and the second item of workpiece information, and
outputting the drawings of the first item and the second item of workpiece information graphically via an output unit, wherein the at least one difference is highlighted in at least one of the drawings.

2. The method according to claim 1, wherein the at least one difference is a different size of the first workpiece and the second workpiece, and the drawings are output scaled to a uniform size.

3. The method according to claim 1, wherein the at least one difference is a different number and/or arrangement of holes in the first workpiece and the second workpiece, and at least one hole is highlighted in a respective drawing.

4. The method according to claim 1, wherein the at least one difference is a different outer contour of the first workpiece and the second workpiece, and wherein the drawings as being output are rotated and/or mirrored such that an overlay of the drawings has a greatest possible area overlap.

5. The method according to claim 1, wherein the drawings are output in an overlayed or juxtaposed manner.

6. The method according to claim 1, further comprising producing an image of a respective workpiece, wherein the first item of workpiece information is selected based on the image.

7. The method according to claim 6, further comprising generating an item of component information from the image, wherein the first item of workpiece information that is most similar to the item of component information is automatically selected.

8. The method according to claim 1, wherein the first item of workpiece information is selected by an operator, and the second item of workpiece information that is most similar to the first item of workpiece information is automatically selected.

9. The method according to claim 1, wherein at least one of the first item and the second item of workpiece information is selected by artificial intelligence.

10. The method according to claim 1, wherein at least the first workpiece is automatically recognized in a position in a metal sheet, and the first item of workpiece information belongs to the first workpiece.

11. A system for assisting in distinguishing between sheet-metal workpieces, the system comprising a memory, a computing unit, and an output unit,
wherein a large number of items of geometric workpiece information are stored in the memory,
wherein each respective item of workpiece information contains a drawing of the respective workpiece, or the computing unit is configured to create the drawing from the respective item of workpiece information,
wherein the computing unit is configured to retrieve at least a first item of workpiece information of a first workpiece and a second item of workpiece information of a second workpiece from the memory, determine at least one difference between the first item and the second item of workpiece information, output the drawings of the first item and the second item of workpiece information graphically via the output unit, and highlight the at least one difference in at least one drawing being output.

12. The system according to claim 11, further comprising a camera for creating an image, and the computing unit is configured to select at least the first item of workpiece information based on the image.

13. The system according to claim 11 wherein a trained model of artificial intelligence is stored in the memory, and the computing unit is configured to use the model to select at least the first item and/or the second item of workpiece information.

14. The system according to claim 11, further comprising an input unit, and the computing unit is configured to receive a selection of the first item of workpiece information from an operator via the input unit.
